(19) United States
(12) Patent Application Publication
(10) Pub. No.: US 2003/0009374 A1
(43) Pub. Date: Jan. 9, 2003

(54) Schemes employing mobile communications

(76) Inventors: Justin Charles Moodie, London (GB); Matthew Peter Travers, London (GB)

Correspondence Address: KENYON & KENYON, 1500 K STREET, N.W., SUITE 700, WASHINGTON, DC, 20005, US

(21) Appl. No.: 09/848,262

(22) Filed: May 4, 2001

(51) Int. Cl. G06F 17/60

(52) U.S. Cl. 705/14

(57) ABSTRACT

In a customer reward scheme, a user who purchases a product or service is provided with a token code. The user enters a token code in a mobile terminal, which transmits the token code to a server. The server causes a value associated with the token code to be added to the user's account. The user receives a message indicating the total value accumulated in the user's account. If the accumulated value in the user's account exceeds a predetermined threshold, the user receives a message containing a question. The user enters an answer to the question into the terminal. If the answer is correct, a bonus value is added to the customer account. The terminal automatically transmits a prestored terminal or user identity code. This identity code is used as an identifier to create and update the user's account. Messages may be addressed to the user by means of the identity code. The messages may include a password which can be used during a subsequent registration process in which the user provides user details which are then associated with the user's customer account and/or during a redemption process in which a value stored against the customer's account is redeemed for a reward. In an alternative, competition application, a competition entry code is broadcast. Competition entrants enter the code into their mobile terminals and send it as a message to an address which accompanies the broadcast. A database of competition entrants is set up using unique identifiers which are sent by the mobile terminals. The received codes are first checked for validity before the unique identifiers are added to the database. One or more winners are selected at random from the database and a password is sent to the mobile terminal of each winner. The winners then log on to a website using their password to collect their prize.

### FIELD OF THE INVENTION

The present invention relates to a system, method, computer program, data structure and apparatus for implementing a customer loyalty, reward or competition scheme using mobile communications terminals.

### BACKGROUND OF THE INVENTION

In conventional loyalty schemes, a customer is awarded points for carrying out transactions with participating parties. The points can be accumulated and exchanged for rewards. In one example of a generic store loyalty scheme, a customer account is automatically credited with points according to the amount of money spent at the store and/or based on the purchase of specified items. The points can be exchanged for a discount on subsequent purchases at the store or for goods on sale at the store or available on order. In another example of a brand loyalty scheme, vouchers or tokens are issued with the purchase of branded goods or services, and may be redeemed with the manufacturer or retailer in exchange for goods, cash, services or entry into a competition. Various other examples are known to those skilled in the art and to the general public.

Loyalty schemes may also be administered electronically over a communications network: for example, internet-based loyalty schemes such as Beenz™, administered by BeenzCom, Inc., and Clickmiles™, administered by Netcentives Inc. and purportedly described in U.S. Pat. Nos. 5,774,870 and 6,009,412.

However, a problem associated with electronic loyalty schemes, including Internet-based schemes and store schemes, is that the user must undergo a registration process before participating in the scheme. The registration process is thought to be necessary to create a unique customer identity, and also to collect marketing information, which is often the ultimate aim of a loyalty scheme. The registration process is nevertheless burdensome on the customer, particularly because it takes place before the customer is entitled to any reward for the scheme.

Loyalty schemes based on physical tokens do not generally require pre-registration, but are cumbersome and inflexible. Moreover, the administrator of the loyalty scheme has no means of interacting with the customer until he or she redeems the tokens.

In some terrestrial cellular communications networks, a pre-payment method has been employed in which users purchase a voucher having a face value and carrying a code, which is revealed after purchase. The user enters the code and sends it to a number printed on the voucher so as to credit the user's account by the face value of the voucher. However, the user's account is simply used to pay for calls made by the user and cannot be redeemed for prizes when the total reaches a certain threshold; at the most, a different tariff is applied depending on the face value of the vouchers purchased. Hence, this method is not suitable for and is not intended for implementing any kind of reward or loyalty scheme.

In conventional competition schemes, users submit their personal details, such as a name, address or contact number, in the hope of being selected at random to win a prize. However, users are often unwilling to submit these details solely for the prospect of winning a prize.

### SUMMARY OF THE INVENTION

In accordance with an embodiment of the present invention, a loyalty scheme is provided in which a user who purchases a product or service is provided with a token code. The user enters a token code in a communications terminal, which transmits the token code over a communications network to a server. The server causes a value associated with the token code to be added to the user's account.

In one more specific embodiment, the communications terminal receives a message informing the user of the total value accumulated in the user's account: this message may be sent in response to the user sending a token code, in response to the total value exceeding a threshold at which the value may be redeemed, or in response to a message from the user, for example.

In accordance with another more specific embodiment of the invention, if the accumulated value in the user's account exceeds a predetermined threshold, the user receives a message at the communications terminal containing a question. The user enters an answer to the question into the communications terminal. If the answer is correct, a bonus value is added to the customer account.

In another more specific embodiment, the communications terminal is connected to a network which automatically transmits a prestored terminal or user identity code. This identity code is used as an identifier to create and update the user's account. Messages may be addressed to the user by means of the identity code. The messages may include a password which can be used during a subsequent registration process in which the user provides user details which are then associated with the user's customer account and/or during a redemption process in which a value stored against the customer's account is redeemed, for example for goods, services, money or competition entry.

Preferably, the communication terminal is a wireless communications terminal. Advantageously, the wireless communications terminal can be identified automatically by the wireless communications network(s) with which it is registered, or the wireless communication terminal automatically transmits an identity code, and the identification code is forwarded to a server. An additional or alternative advantage of a wireless communications terminal is that it is likely to be available to the user at the point of purchase or use of the goods or services purchased; hence, although a voucher number may initially be provided in physical form, it is easily transferred into electronic form at the wireless communications terminal.

In another embodiment of the present invention, a competition scheme is provided in which a competition entry code is broadcast. Competition entrants enter the code into their mobile terminals and send it as a message to an address which accompanies the broadcast. A database of competition entrants is set up using unique identifiers which are sent by the mobile terminals. The received codes are first checked for validity before the unique identifiers are added to the database. One or more winners are selected at random from the database and a password is sent to the mobile terminal of each winner. The winners then log on to a website using their password to collect their prize.

Embodiments of the invention include: one or more servers connected or connectable to the communications network and arranged to implement the scheme or schemes described above; a computer program for execution by the one or more servers in order to implement the scheme; a data structure stored by the one or more servers in order to implement the scheme; a carrier carrying the computer program; a carrier carrying the data structure; and a signal transmitted from or to the communications terminal in order to implement the scheme.

### BRIEF DESCRIPTION OF THE DRAWINGS

Specific embodiments of the present invention will now be described with reference to the accompanying drawings, in which:

FIG. 1 is a schematic diagram of a system architecture in an embodiment of the present invention;

FIGS. 2a to 2c are diagrams of different processes performed in the embodiment;

FIG. 3 is a flow diagram of an account value information process in the embodiment;

FIG. 4 is a flow diagram of a bonus question process in the embodiment;

FIG. 5 is a flow diagram of a retrospective registration process in the embodiment;

FIG. 6 is a diagram of different processes involved in an alternative embodiment of the present invention;

FIG. 7 is a flow diagram of a competition entry process in the alternative embodiment; and

FIG. 8 is a flow diagram of a competition winner notification process in the alternative embodiment.

### DETAILED DESCRIPTION OF THE PREFERRED EMBODIMENTS

In an embodiment of the present invention, a system implements a loyalty scheme that combines a voucher based loyalty scheme with the messaging functionality of a mobile terminal.

In the embodiment, the user buys a product including a voucher which is concealed at the time of purchase, for example within the product packaging. Printed on the voucher is a value expressed as a number of loyalty points, a voucher number, a telephone number, and instructions on how to use the voucher. Following the instructions, the user enters the voucher number into the mobile terminal as a text message and sends the text message to the telephone number given on the voucher.

In response, the user receives a text message confirming the value of the voucher number and the total number of points in the user's loyalty account.

For example, the user who has not previously used the loyalty scheme purchases a first product containing a voucher worth 100 points, carrying a voucher number N1. The user enters the number N1 as a text message and sends it to the telephone number printed on the voucher. In response, the user receives a text message welcoming him to the loyalty scheme, and confirming the voucher value of 100 points and the account total of 100 points.

The user then buys a second product containing a voucher worth 200 points, carrying a voucher number N2. The user enters the number N2 as a text message and sends it to the telephone number printed on the voucher—this may be the same number or a different number to that used for the first product. In response, the user receives a message confirming the voucher value of 200 points and the account total of 300 points.

If the account total reaches a predetermined threshold, the confirmation message may offer the user the opportunity to earn bonus points (e.g. 500 points) for answering a multiple choice question contained in the message. The question may be a general knowledge question, market research or brand-related question. The user sends a text message in reply indicating one of the multiple-choice answers. If the answer is correct, the user receives a message congratulating them and confirming the new account total (e.g. 800 points). If the answer is incorrect, the user receives a text message in commiseration, explaining that there will be another opportunity to gain bonus points when the next threshold is reached.

The account total may reach a value which can be redeemed to collect a prize. The user receives a text message offering the prize, explaining the registration requirements and including a password which has been uniquely generated for that user.

To collect the prize, the user must provide registration details. To register online, the users accesses a loyalty scheme web site and logs in using his mobile telephone number and the password. The web site then generates a form which requires the user's contact information and answers to market research questions. The user can then choose to redeem the number of points required for a prize, or to continue accumulating points towards a more valuable prize.

The user may alternatively register offline by calling or writing to a customer service center, supplying the telephone number and password, and answering the form questions which are asked over the telephone or supplied by mail on a printed form.

The customer service department of the loyalty scheme operator processes the user's contact information and sends the prize by mail or courier. The market research data is stored in a database and may be used for targeted marketing directed at the user or groups of users.

The system uses the mobile phone number as a user identifier. The mobile phone number is appended automatically to all text messages sent by the mobile terminal and can therefore be used to set up and increment a user's account even before registration. This removes the conventional registration barrier for interactive promotions. Users who are unwilling to provide registration details merely for the prospect of winning prizes are much more likely to provide those details once they know they have won a prize.

The mobile phone number need not be permanently associated with a particular mobile terminal, but may be stored in a removable Subscriber Identity Module (SIM) which can be transferred between mobile terminals. Hence, the mobile phone number can be envisaged as a user identifier as well as an identifier of a particular mobile phone; this is particularly true where the use of the SIM is protected by a password known only to the user.

The system uses a password as a security reference; the mobile telephone number itself is not secure, and is likely to be distributed widely by the user. The password is received by the user terminal associated with the phone number and may therefore be kept secure by the user. Once the password has been used, it cannot be reused to redeem points from the user's account.

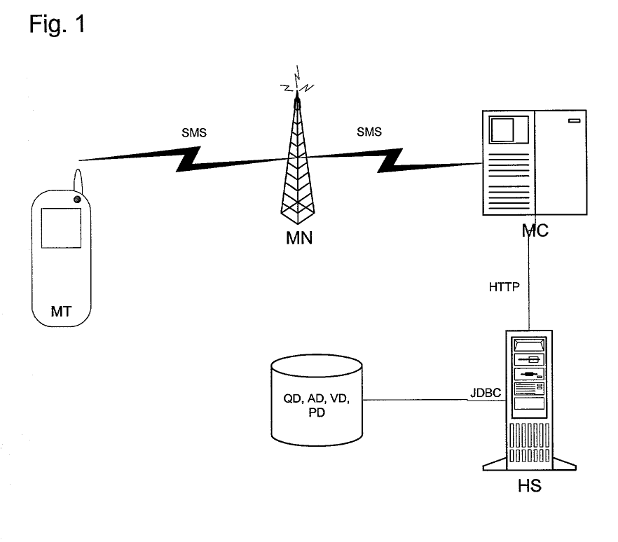

One possible technical implementation of an embodiment of the loyalty scheme will now be described. As shown in FIG. 1, the system on which the loyalty scheme is implemented comprises a plurality of mobile terminals MT able to communicate using an SMS (Short Message Service) protocol via a wireless mobile network MN to a messaging center MC. The messaging center MC is able to communicate over the Internet using the Hypertext Transfer Protocol (HTTP) with a host server HS, which accesses an account database AD, a question database, a product database PD and a voucher database VD using Java Database Connectivity (JDBC) protocols.

The mobile terminals MT may be mobile telephones with SMS text messaging functions. However, it is not essential that the mobile terminals have telephony functions in addition to text messaging functions. Messaging or paging protocols other than SMS may be used.

The mobile network MN may be a digital terrestrial cellular network such as a GSM (Groupe Speciale Mobile) network which supports SMS protocols. Alternative data transmission protocols may be used, such HSCSD (High Speed Circuit Switched Data) or GPRS (General Packet Radio Service), over suitably enabled networks.

The messaging center MC may be a Virtuacom™ messaging center, which acts as a gateway between the mobile network MN and the host server HS and translates SMS messages from the mobile terminals MT to HTTP requests to the host server HS. The messaging center is connected to the host server HS via a network such as the Internet.

The host server HS runs application software which manages user accounts, bonus questions and registration via a website. These functions may be hosted by separate applications running on separate servers connected to a network. Each application may be load-balanced across several servers.

The account database AD stores user account information and passwords, stores the state of any question sessions with each user, and archives records of completed transactions on user accounts. The voucher database VD stores details of valid voucher numbers and their values. The databases may be hosted on separate servers from each other and from the host server HS, connected to a common network.

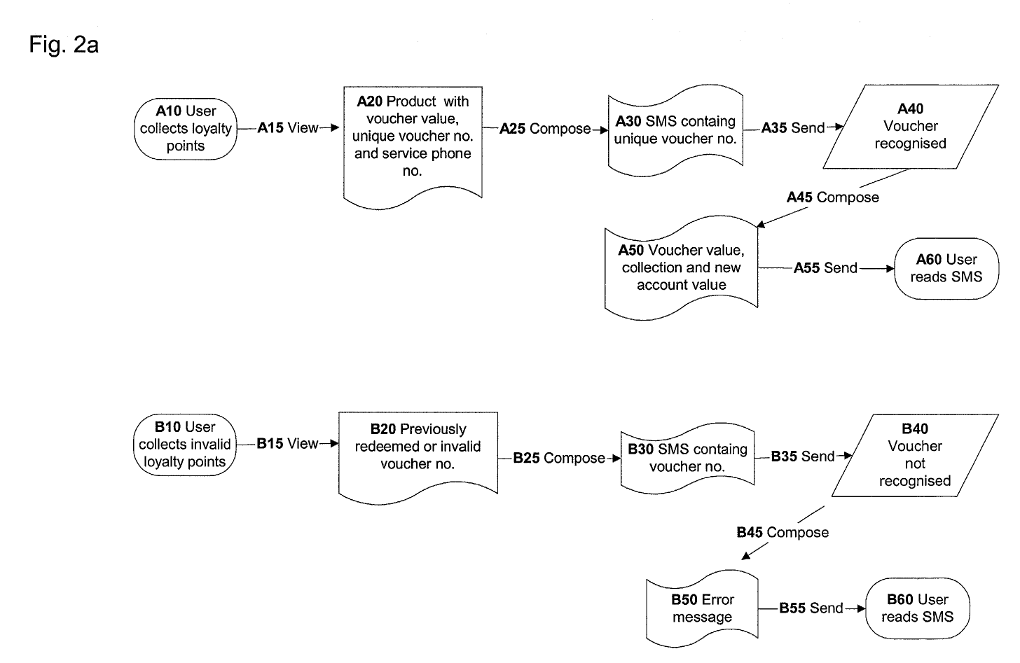

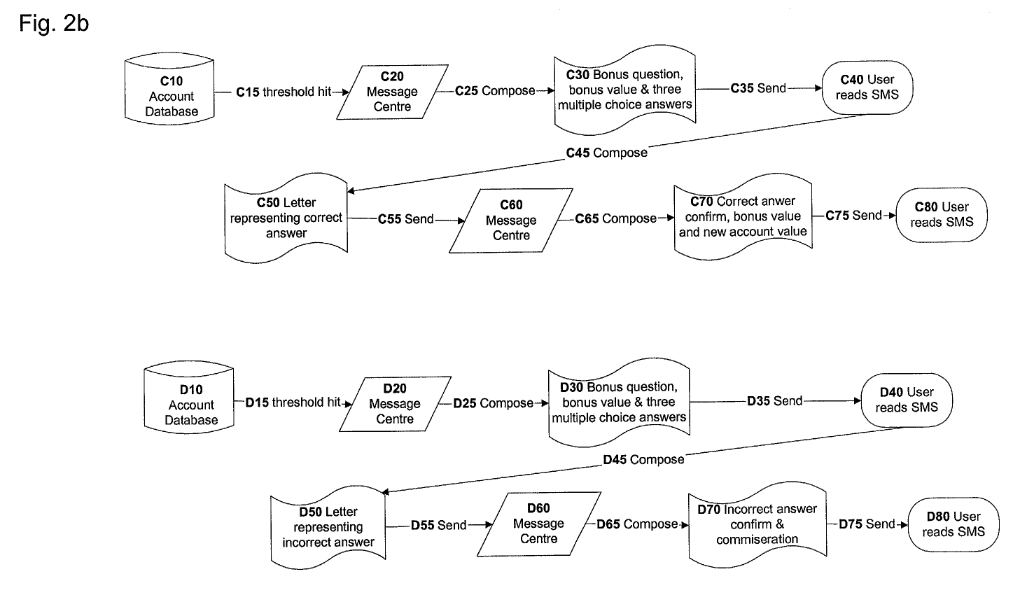

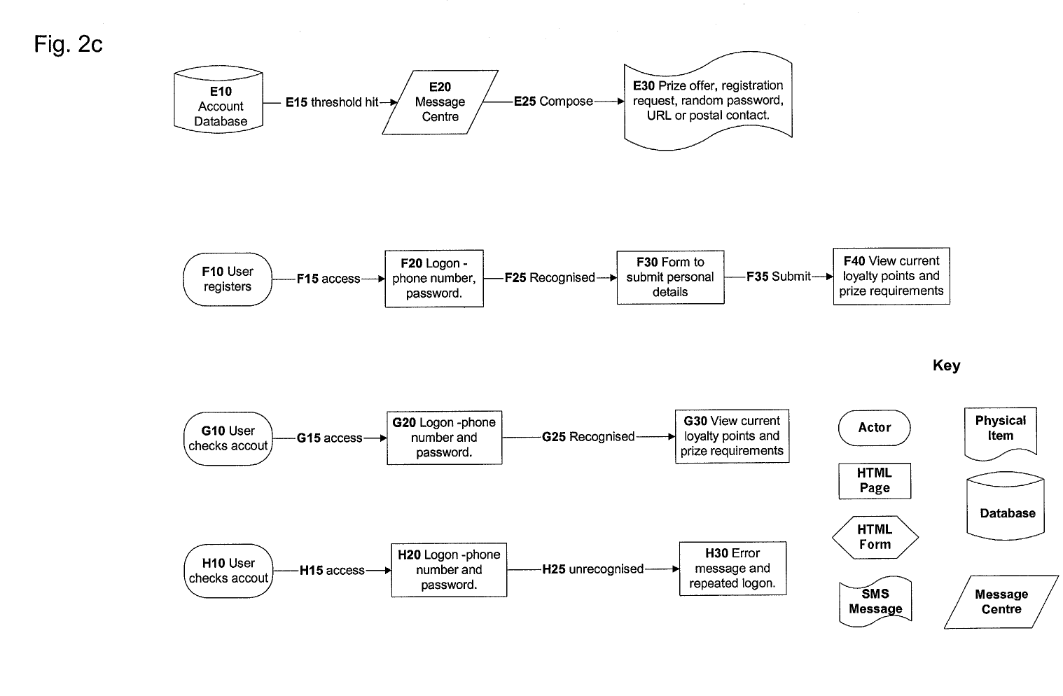

Different processes performed by the system will now be described in detail with reference to FIGS. 2a to 2c.

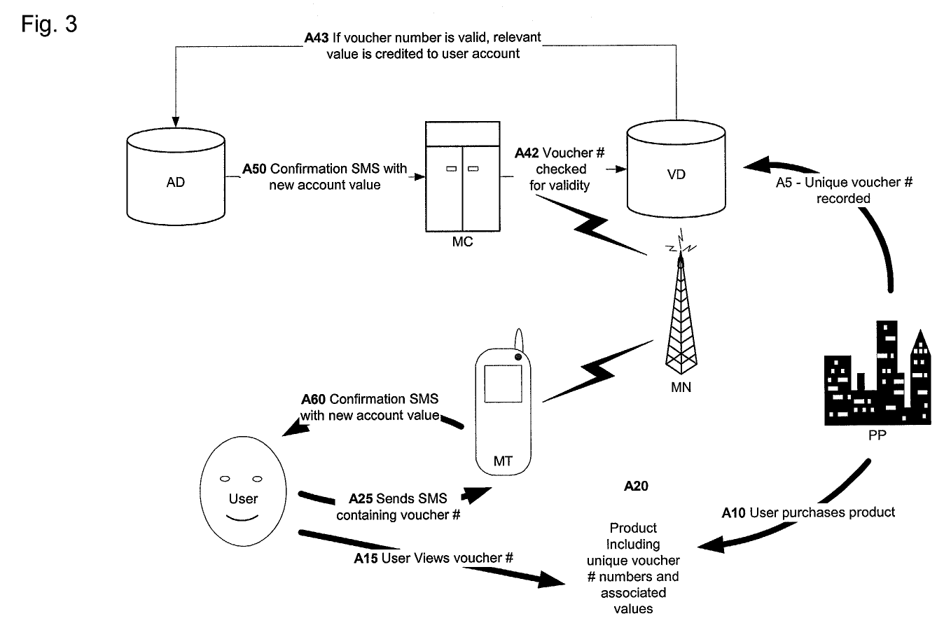

In process A, which is further illustrated in FIG. 3, the user collects (A10) loyalty points by purchasing a product (A20). The product has been manufactured at a production plant PP from which the voucher numbers and values of vouchers of manufactured products are submitted (A5) to the voucher database VD, where they are stored with respective associated flags to indicate whether each voucher has been redeemed.

The user opens the product packaging and reads (A15) the number of the voucher contained therein, and the telephone number printed on the voucher. The user then enters (A25) the voucher number into the mobile terminal MT as a text message (A30) and sends (A35) the text message over the mobile network MN as an SMS message using the telephone number on the voucher. The mobile terminal MT includes its own telephone number in the SMS message: this is a standard feature of the SMS protocol which allows the recipient of an SMS message to send a reply.

The messaging center MC (A40) receives the SMS message and sends it to the host server 8, where the voucher number is checked (A42) against the voucher database VD. If the voucher number exists in the voucher database and is not flagged as having been redeemed, the host server 8 credits (A43) the value of the voucher to a user account indexed by the telephone number of the mobile terminal MT on the account database AD. The value of the voucher may be stored as a separate field on the voucher database VD, or may be derived from the voucher number by an algorithm executed by the host server 8.

The host server 8 retrieves the updated account total of the user account from the account database AD and composes (A45) an SMS message (A50) which is forwarded to the messaging center MC for transmission (A55) to the mobile terminal MT. The SMS message confirms the value of the voucher and the updated total account value. The user reads (A60) the SMS message on the mobile terminal MT.

Process B is an alternative to process A in a case where the voucher number is invalid. The user collects (B10) an invalid voucher—for example, a voucher which has already been used. The user views (B15) the invalid voucher (B20) and composes (B25) an SMS message (B30) comprising the invalid voucher number. The user sends (B35) the SMS message to the messaging center (B40), which forwards the message to the host server HS. The host server HS checks the voucher number against the voucher database VD and finds that the number is invalid: either the number is not present at all in the database VD, or it is present but flagged as already used. The host server HS composes (B45) an error message (B50) and sends (B55) it to the messaging center MC for transmission to the user. The user reads (B60) the error message and is informed that the voucher number is not valid. In this way, fraud by reuse of voucher numbers is prevented. Fraud by guessing voucher numbers is prevented by using a voucher number format with a large degree of redundancy, so that only a small number of possible voucher numbers are actually valid at any one time.

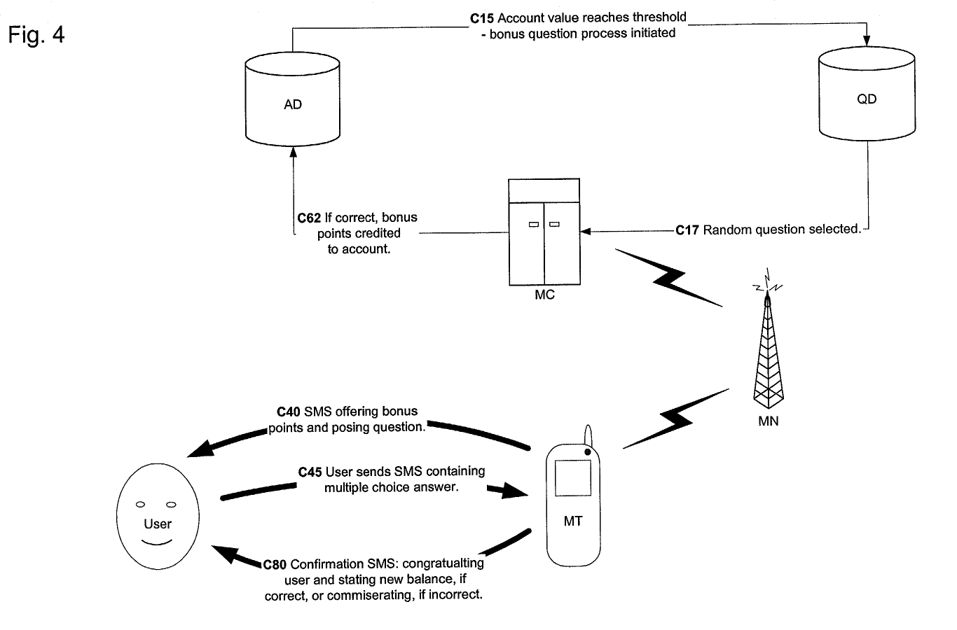

In process C, which is further illustrated in FIG. 4, a bonus question function is activated when a user's account value in the account database AD (C10) is incremented so as to equal or exceed a predetermined threshold, or one of a progressive series of thresholds. This may occur as a result of a valid voucher number being submitted in process A, or may be caused by the host server HS incrementing the total in response to some other condition, such as the user providing registration details. The host server HS compares the updated total value with the predetermined threshold to determine (C15) whether the threshold has been met. If it has, the host server HS randomly selects a multiple-choice question from the question database QD and composes a message addressed to the telephone number of the corresponding user, as stored on the account database AD. The message also includes the value of the bonus question, i.e. the number of points which will be added to the user's account if the answer is correct. The value may be stored on the question database QD or may determined by the host server HS according to the level of the predetermined threshold, for example. The message is sent to the messaging center (C20) which composes (C25) an SMS message (C30) and sends it (C35) to the user. The user reads (C40) the message and enters (C45) a letter (C50) corresponding to one of the multiple-choice answers to the question. The user sends (C55) the letter as an SMS message, which is received at the messaging center MC (C60) and forwarded to the host server HS. The host server HS looks up the state of the question session for that user according to the telephone number supplied in the SMS message and determines whether the given answer is the correct one by looking up the correct answer in the question database QD. If the answer is correct, the host server HS adds (C62) the value of the bonus question to the user's account on the account database AD and composes a message to the mobile terminal confirming that the answer is correct. The message is forwarded to the messaging center MC which converts (C65) the message to an SMS message (C70) which is sent (C75) to the mobile terminal MT. The user reads the message (C80).

Process D is an alternative to process C in the case where the user gets the answer to the bonus question wrong. The process proceeds in the same way as process C, with similar process steps carrying the same reference numeral but preceded by ‘D’, until step D50 where the user enters the wrong answer to the multiple choice question. The user sends (D55) an SMS message containing the wrong answer, which is received at the messaging center MC (D60) and forwarded to the host server HS. The host server HS looks up the state of the question session for that user according to the telephone number supplied in the SMS message and determines whether the given answer is the correct one by looking up the correct answer in the question database QD. In this case, the answer is wrong, so no points are added to the user's account. The host server HS composes a message to the mobile terminal MT stating that the answer is wrong. The message is forwarded to the messaging center MC which converts (D65) the message to an SMS message (D70) which is sent (D75) to the mobile terminal MT. The user reads the message (D80).

In an alternative embodiment, the bonus question is not a multiple-choice question, but a request for information from the user. The requested information may concern the user's lifestyle or opinions. In this case, bonus points are added to the user's account if any answer at all is received, although some analysis of the answer may first be carried out to determine whether it is a meaningful or plausible answer before the bonus points are credited and the information is stored on a database of marketing information.

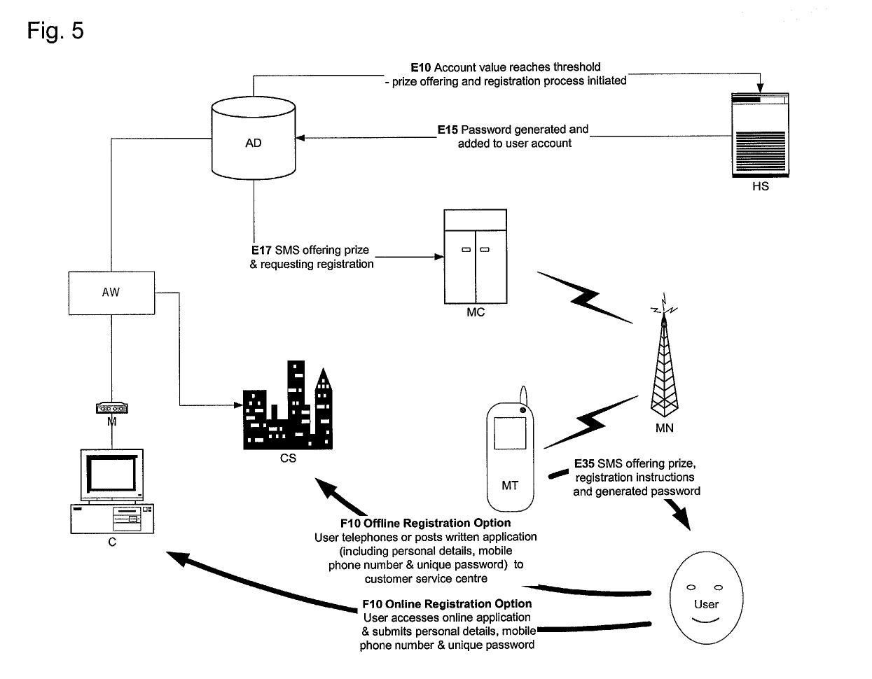

In a process E, further illustrated in FIG. 5, a prize offer is activated when the total value of a user's account equals or exceeds a second predetermined threshold, or one of a progressive series of second thresholds, which may or may not have the same value as that at which the bonus question function is activated. Preferably, the second threshold is higher than the lowest threshold at which the bonus question function is activated, by a difference equal to the value of the bonus question so that answering the bonus question correctly will activate the prize function.

The host server HS detects (E15) from the account database AD (E10) that the value of a user's account has met or exceeded the second threshold. This may occur as a result of a valid voucher number being submitted in process A, or may be caused by the host server HS incrementing the total in response to some other condition, such as the user providing registration details.

The host server HS then generates a unique password, which may be a function of the date and/or time and the user's telephone number, and stores (E15) the password in the account database AD, indexed against the user's account. The password is included (E17) in a message addressed to the user, which asks the user to register in order to collect a prize, and gives a URL (Uniform Resource Locator) and postal address for registration. The message is passed to the messaging center MC (E20), where an SMS message containing the message is composed (E25) into an SMS message (E30) which is sent to the user. The user reads (E35) the message and may initiate a registration process F.

In the registration process F10, the user may register online by accessing (F15) an account management website AW using a web-enabled computer C connected to the Internet using a modem M or other device appropriate to the user's network. The computer C receives a web page (F20) requesting input of the user's telephone number and password. The web page is provided by a web server having access to the account database AD, from which the web server checks the input password against the password stored against the user account indexed by the input telephone number. If the input telephone number is recognized and the input password matches the stored password (F25), the web server provides a form (F30) which the user fills in with the requested personal details and marketing information, and submits (F35) to the web server. The web server stores the personal details against the user's account in the account database AD and adds the marketing information to a marketing information database. Further, the web server sends a web page to the computer C displaying the user's account total of loyalty points and indicating what prizes are available and what prizes require more points than the account total. The user may select an option to redeem some or all of the points for a prize, in which case the web server generates an order to a customer service center to deliver the prize to the user.

Alternatively, in process G, the user may choose to continue accumulating points and may log on later (G10) using the same telephone number and password (G20) in order to check the current account total and prize requirements (G40) and optionally to redeem the points for a more valuable prize.

In process H, the user wishes to check his account (H10) but logs on with the wrong phone number or password (H20). The web server checks the input phone number and password against the account database AD but does not find a match (H25). The web server sends to the computer C a web page (H30) including an error message and a request to reattempt login.

Since the loyalty scheme uses existing communications infrastructure such as the Internet and wireless messaging networks, it can be implemented by setting up the host server HS, the various databases and the messaging center MC using suitable hardware and software. The software may be recorded on a carrier such as a floppy disc or CD-ROM for loading onto the hardware, or may be downloaded via a network such as the Internet. Further technical details of these components in one specific embodiment will now be described.

The messaging center MC may be a Virtuacom™ messaging center which runs Virtuacom™ information on demand (IOD) scripts named reward and question, placed in the ACOM scripts directory.

The reward script performs the following actions:

i. Get the user's phone number.

ii. Get the user's voucher code.

iii. Send an HTTP request to the MLS Server consisting of the phone number and the voucher code, e.g.

hhttp://Ionlab3.london.agency.com/loyalty/RewardServlet?pno=0796707070&code=A1B2

iv. If code is valid send a congratulations message, including number of points won, total number of points in account, and website password (if not registered) to the user's phone.

v. If code is not valid send an error message to the user's phone.

The question script performs the following actions:

i. Get the user's phone number.

ii. Get the user's answer.

iii. Send an HTTP request to the host server consisting of the phone number and the given answer.

iv. If the user has won send a winning message, including number of points won and total number of points in account, to the user's phone.

v. If the user has lost send a commiseration message, including number of points left in account to the user's phone.

The host server HS runs the following scripts:

### RewardServlet Class

The RewardServlet Java servlet is merely a wrapper to call the RewardHandler class methods—see below.

The RewardServlet servlet needs to be registered with the web server on the quiz server machine.

When compiling the RewardServlet servlet, CLASSPATH needs to be able to locate the RewardHandler class.

### QuestionServlet Class

The QuestionServlet Java servlet is a wrapper to call the QuestionHandler class methods—see below.

The QuestionServlet needs to be registered with the web container, which may be hosted on the host server HS..

When compiling the QuestionServlet servlet, CLASSPATH needs to be able to locate the QuestionHandler class.

### RewardHandler Class

The Java class named RewardHandler controls the operation of user question sessions. This class is used by the RewardServlet servlet, and thus must be visible via CLASSPATH when compiling the RewardServlet class (see above).

The RewardHandler class has the following public methods:

RewardHandler(String phone_number, String reward_code)-constructor.

| | |
|---|---|
| String ProcessRewardCode() - | checks the validity of the given |
| | code and retrieves the code's points |
| | value. If valid, the user's Account |
| | balance is updated. Returns account |
| | status message. |

### QuestionHandler Class

The Java class named QuestionHandler receives user responses to bonus questions i.e. the chance to win extra loyalty points. This class is used by the QuestionServlet servlet, and thus must be visible via CLASSPATH when compiling the QuestionServlet class (see above).

The QuestionHandler class has the following public methods:

QuestionHandler(String phone_number, String answer)-constructor.

| | |
|---|---|
| String processAnswer() - | Checks the user's answer against existing |
| | user question sessions, identified by the |
| | phone number. Returns a message |
| | confirming a win or lose, or error if there is |
| | no existing session for the user. |

### Account Class

Instances of the Java class named Account represent the state of a user's account as reflected in the account database AD. Properties such as first_name, last_name, etc remain empty until the user registers on the web site AW and the database is updated AD. Until a user registers only the phone_number, balance, and next_promotion properties are used. This class is used by the RewardHandler class, and thus must be visible via CLASSPATH when compiling the RewardHandler class (see above).

The Account class has the following public methods:

| | |
|---|---|
| Account(String phone_number) - | constructor. Retrieves all user |
| | details from account database |
| | AD, or creates a new account |
| | if no record exists. |
| int updateAccount(int loyalty_points) - | Adds reward points to user |
| | account and checks for |
| | threshold hits. When a |
| | user's account balance |
| | exceeds a threshold hit value |
| | a promotion or question |
| | event is triggered, and an |
| | SMS is sent to the user. |

The database schema of the databases is given below.

Table: user_accounts

| | | |
|---|---|---|
| phone_number | number(15, 0) | - user phone number |
| | | [Primary Key] |
| user_password | varchar(10) | password |
| loyalty_points | number(6,0) | number of loyalty points |
| next_promotion | number(6,0) | value of next threshold hit |
| first_name | varchar(50) | user's first name |
| last_name | varchar(50) | user's last name |
| email_address | varchar(100) | user's email address |
| address_line1 | varchar(100) | first line of user's address |
| address_line2 | varchar2(100) | second line of user's address |
| address_town | varchar2(50) | town |
| address_postcode | varchar2(7) | postcode |
| address_county | varchar2(50) | county/state |

Table: reward_codes

| | | |
|---|---|---|
| reward_code | varchar(15) | reward codes. [Primary Key] |
| prize_code | varchar(15) | value of the reward in loyalty |
| | | points. |
| phone_number | number(15, 0) | user phone number |
| data_redeemed | char(20) | text representation of date/time. |
| code_status | char(1)) | 0 = reward not claimed; 1 = |
| | | claimed. |
| Table: questions | | |
| question_id | varchar(10) | unique question identifier. |
| subject | varchar(20) | subject |
| question | varchar(120) | the text of the question |
| answer_a | varchar(20) | possible answer A |
| answer_b | varchar(20) | possible answer B |
| answer_c | varchar(20) | possible answer C |
| answer_d | varchar(20) | possible answer D |
| correct_answer | char(1) | correct answer, one of A, B, |
| | | C or D |
| Table: promotions | | |
| promotion_id | varchar(10) | unique promotion identifier. |
| promotion_text | varchar(160) | promotion text |

Table: threshold_events

| | | |
|---|---|---|
| points_needed | number(6, 0) | points needed to trigger event |
| event_type | char(1) | P = promotion, Q = Question |
| event_id | varchar(10) | ID of promotion or question |

Table: question_sessions

| | | |
|---|---|---|
| question_id | varchar2(10) | question identifier |
| phone_number | number(15, 0) | user phone number |
| session_start | char(20) | representation of session start |
| | | date/time |
| session_end | number(15, 0) | date/time of user response |
| | | (if any) in secs |
| expected_answer | char(1) | correct answer to question sent to |
| | | user |
| session_status | char(1) | P = pending, W = won, |
| | | L = lost, A = abandoned. |
| Table: products | | |
| product_id | varchar2(10) | unique product ID [Primary Key] |
| product_name | varchar2(100) | product name |
| product_description | varchar2(1024) | product description |
| product_category | varchar2(100) | product section [Foreign Key] |
| product_cost | number(6) | cost of product, in loyalty points |
| Table: categories | | |
| product_category | varchar2(100) | product type [Primary Key] |

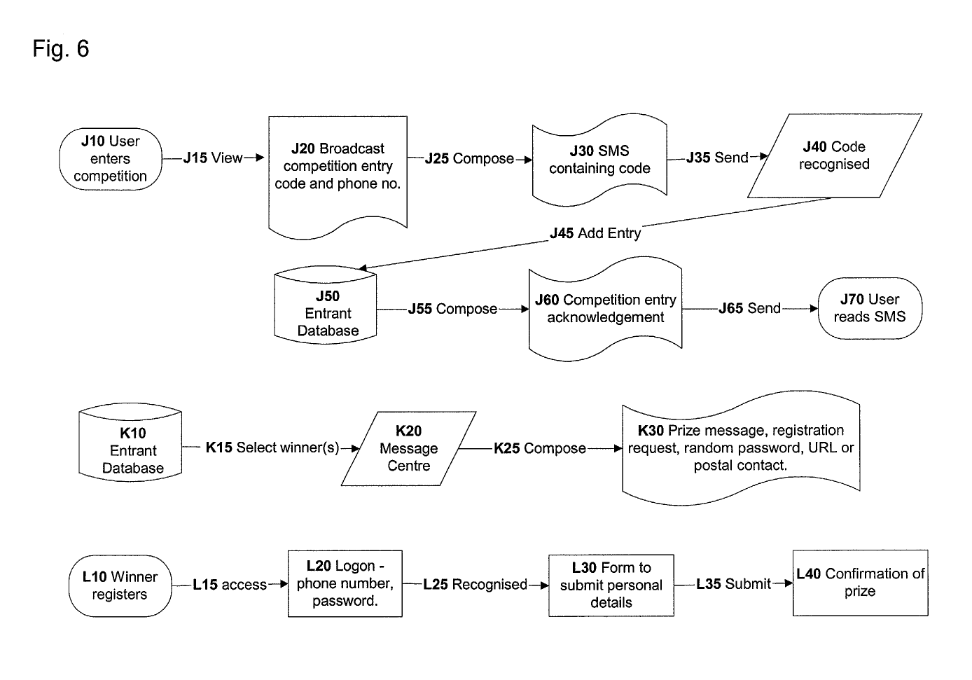

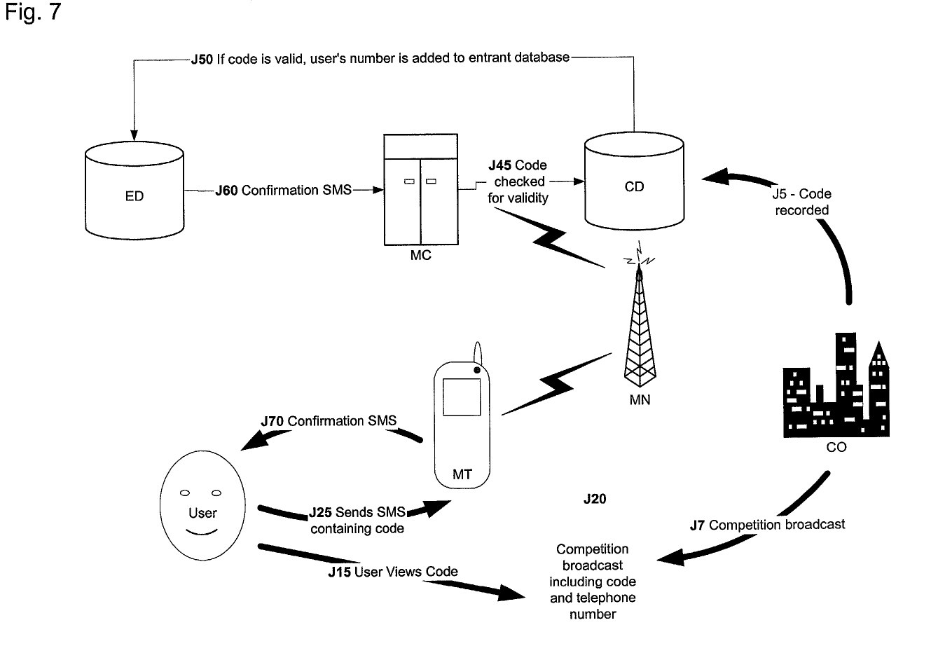

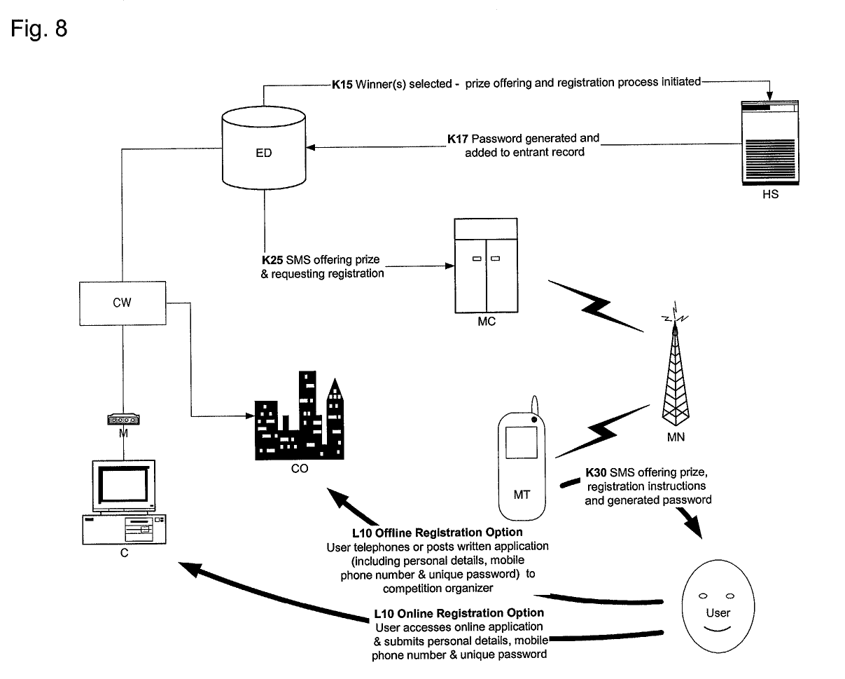

An alternative embodiment will now be described with reference to FIGS. 6 to 8, in which a code is broadcast to allow users to enter a competition using their mobile terminals, without the need to provide any registration details. The alternative embodiment uses an architecture which is similar to that shown in FIG. 1 except for the content of the databases, and similar components are given the same reference numerals.

A competition organizer CO generates a code which will be unique to the current competition, and records (J5) the code in a code database CD, together with associated competition information such as a closing date for entries. The competition organizer broadcasts (J7) details (J20) of the competition, including the code and a telephone number, as well as instructions for entry into the competition. The code may be displayed on posters, or broadcast on television or radio, for example. Following the instructions, the user composes (J25) and sends (J35) a message (J30) containing the code to the specified telephone number. The messaging centre MC and host server HS receive the message and check (J45) the code for validity against the code database CD. If the code is present and the current date doesn't exceed the closing date (J40), the user's telephone number, which was transmitted automatically with the message (J30), is added (J50) as a record to a database of entrants ED. The host server HS composes (J55) a confirmation message (J60) confirming entry to the competition, and sends it (J65) via the messaging centre MC. The user reads (J70) the message received on the mobile terminal (MT). If the code is invalid, the user receives a message to that effect.

Once the closing date has expired, one or more winning entries are selected (K15) randomly or pseudo-randomly from the database of entrants ED. For each winning entry, the host server HS generates (K17) a unique password and composes (K25) a message (K30) confirming that a prize has been won and asking the user to claim a prize using the password and a specified URL or postal address. The winner may register (L10) online by accessing (L15) a competition website CW using a computer C and modem M connected to the Internet. The user logs on (L20) by entering the phone number of the mobile terminal MT and the password. If the password is recognised (L25) by comparing the logon details with the winning entrants' details and passwords stored on the entrants database ED, the competition website generates a form (L30) for the winner to enter details, such as an address for delivery of the prize. The user submits (L35) the completed form and the competition website displays a confirmation message (L40), stating that the prize is on its way. If the logon details are not recognised, a web page will be displayed to that effect.

Optionally, a commiseration message may be sent to the unsuccessful entrants after the closing date. The entrants database ED may also be used for marketing purposes, for example by sending promotional messages to the numbers stored.

The above embodiments are described purely by way of example and may be varied without departing from the spirit and scope of the present invention.

In particular, the present invention is not limited to the use of SMS for messaging. Any messaging system is suitable in which the address of the sending terminal may be determined automatically. It is not essential that the terminal sends its phone number or address, if the address can be determined by the wireless network and passed on to the messaging centre; this could be done using an accurate location of the mobile terminal, for example. Some other identifier of the mobile terminal may be used, and may be translated into an address using a look-up table.

The voucher or code may be provided in a format which can be read automatically by a mobile terminal equipped with a suitable reading device, such as a magnetic swipe card, a bar code, or an RF transponder, for example.

The functions of the messaging centre MC and the host server HS may be combined, or distributed over different hardware devices. Likewise, the databases may be stored on the same storage device or distributed across different storage devices.

What is claimed is:

1. In a reward scheme in which users accumulate points in respective user accounts, which points are redeemable for rewards, a method comprising:
a) receiving a voucher carrying a voucher code;
b) inputting the voucher code to a mobile terminal; and
c) transmitting the voucher code from the mobile terminal over a wireless network to a predetermined network address.

2. A method according to claim 1, wherein step c) includes transmitting an address of the mobile terminal on the wireless network to the predetermined network address.

3. A method according to claim 1, wherein the address of the mobile terminal is automatically transmitted with the voucher code.

4. A method according to claim 1, further including the step of:
d) receiving a message at the mobile terminal stating a value of the voucher.

5. A method according to claim 4, wherein step d) includes the step of receiving a message stating the number of points in the respective user's account after addition of the value of the voucher.

6. A method according to claim 1, further including the step of:
e) receiving a message at the mobile terminal stating the number of points in the respective user's account after addition of a value of the voucher.

7. A method according to claim 1, further including the step of:
e) receiving a message at the mobile terminal, the message including a question;
f) inputting an answer to the question at the mobile terminal; and
g) transmitting the answer to the predetermined network address or to another predetermined network address.

8. A method according to claim 7, further including the step of:
h) receiving a message at the mobile terminal indicating a number of points added to the respective user's account in response to step g).

9. A method according to claim 7, further including the step of:
h) receiving a message at the mobile terminal stating that the answer transmitted at step g) was incorrect.

10. A method according to claim 1, further including the step of:
i) receiving a message at the mobile terminal, the message including a password;
j) submitting said password, together with personal data; and
k) receiving a reward.

11. A method according to claim 10, wherein in step j) said password and personal data are submitted electronically over a network.

12. A method according to claim 11, wherein step j) includes the steps of logging into a server over the network using said password, receiving from the server a request for said personal data, and submitting said personal data to the server in response to said request.

13. A method according to claim 10, wherein step k) includes receiving the reward at a location determined by the personal data submitted at step j).

14. In a reward scheme in which users accumulate points in respective user accounts, which points are redeemable for rewards, a method comprising:
a) receiving a voucher carrying a voucher code;
b) inputting the voucher code to a mobile terminal; and
c) transmitting the voucher code from the mobile terminal over a wireless network to a predetermined network address, together with an address of the mobile terminal.

15. In a reward scheme in which users accumulate points in respective user accounts, which points are redeemable for rewards, a method comprising:
a) receiving a voucher carrying a voucher code;
b) inputting the voucher code to a mobile terminal;
c) transmitting the voucher code from the mobile terminal over a wireless network to a predetermined network address; and
d) receiving a message at the mobile terminal stating a value of the voucher.

16. In a reward scheme in which users accumulate points in respective user accounts, which points are redeemable for rewards, a method comprising:
a) receiving a voucher carrying a voucher code;
b) inputting the voucher code to a mobile terminal;
c) transmitting the voucher code from the mobile terminal over a wireless network to a predetermined network address;
d) receiving a message at the mobile terminal, the message including a question;
e) inputting an answer to the question at the mobile terminal; and
f) transmitting the answer to the predetermined network address or to another predetermined network address.

17. In a reward scheme in which users accumulate points in respective user accounts, which points are redeemable for rewards, a method comprising:
a) receiving a voucher carrying a voucher code;
b) inputting the voucher code to a mobile terminal;
c) transmitting the voucher code from the mobile terminal over a wireless network to a predetermined network address;
d) receiving a message at the mobile terminal, the message including a password;
e) submitting said password, together with personal data; and
f) receiving a reward.

18. A method of registering user details on a user database, comprising:
a) sending a message from a mobile terminal to a predetermined network address, the message including a unique identifier associated with the mobile terminal and/or the user of the mobile terminal, such that the unique identifier is entered on the user database; and
b) subsequently submitting the user details to the user database together with the unique identifier or a code related thereto.

19. A method according to claim 18, wherein step a) is performed over a first, wireless network and step b) is performed over a second network different from the first network.

20. A method according to claim 18, wherein the message includes a code entered by a user.

21. In a competition scheme in which users enter a competition and at least one winner is selected from the entered users, a method comprising:
a) receiving a competition entry code;
b) inputting the competition entry code to a mobile terminal; and
c) transmitting the competition entry code from the mobile terminal over a wireless network to a predetermined network address.

22. A method according to claim 21, wherein step c) includes transmitting an address of the mobile terminal on the wireless network to the predetermined network address.

23. A method according to claim 21, wherein the address of the mobile terminal is automatically transmitted with the competition code.

24. A method according to claim 21, further including the step of receiving a message at the mobile terminal confirming entry to the competition.

25. A method according to claim 21, further including:
d) receiving a message at the mobile terminal, the message including a password;
e) submitting the password together with personal data; and
f) receiving a prize.

26. In a competition scheme in which users enter a competition and at least one winner is selected from the entered users, a method comprising:
a) receiving a competition code;
b) inputting the competition code to a mobile terminal; and
c) transmitting the competition code from the mobile terminal over a wireless network to a predetermined network address, together with an address of the mobile terminal.

27. In a competition scheme in which users enter a competition and at least one winner is selected from the entered users, a method comprising:
a) receiving a competition code;
b) inputting the competition code to a mobile terminal;
c) transmitting the competition code from the mobile terminal over a wireless network to a predetermined network address;
d) receiving a message at the mobile terminal, the message including a password;
e) submitting said password, together with personal data; and
f) receiving a prize.

28. In a reward scheme in which users accumulate points in respective user accounts stored on a database, which points are redeemable for rewards, a method comprising:
a) receiving from a mobile terminal a message containing a voucher code and an identifying code; and
b) adding a points value derived from the voucher code to one of the user accounts selected according to the identifying code.

29. A method according to claim 28, wherein the identifying code is a mobile network address transmitted by said mobile terminal.

30. A method according to claim 29, wherein the identifying code is transmitted automatically by said mobile terminal.

31. A method according to claim 28, wherein step b) includes accessing a database of voucher codes, determining from said database whether the received voucher code is valid, and adding said points value only if the received voucher code is valid.

32. A method according to claim 28, including the further steps of:
c) determining whether the points value of the user account meets a predetermined criterion; and, if the predetermined criterion is met:
d) sending a substantially unique password to the mobile terminal.

33. A method according to claim 32, wherein step d) includes storing said substantially unique password against a respective customer record in said database.

34. A method according to claim 28, including the further steps of:
c) determining whether the points value of the user account meets a predetermined criterion; and, if the predetermined criterion is met:
d) sending a message to the mobile terminal, the message containing a question.

35. A method according to claim 34, including the further steps of:
e) receiving from the mobile terminal a message containing an answer to the question; and, in response to said answer:
f) adding a further points value to the respective user's account.

36. A method according to claim 35, wherein step f) includes the steps of determining whether the received answer meets a predetermined criterion, and if so, adding the further points value to the respective user's account.

37. In a reward scheme in which users accumulate points in respective user accounts stored on a database, which points are redeemable for rewards, the database including for each user a password and identifying code, a method comprising:
a) receiving a password and identifying code from a user, the identifying code representing the network address of a mobile terminal associated with the user;
b) determining from the database whether the password and identifying code match an account record for the user;
c) receiving personal data from the user; and, if the password and identifying code match the account record for the user:
d) storing the personal data against the account record for the user.

38. A method according to claim 37, wherein step d) includes initiating the issue of a reward to the user.

39. A method according to claim 38, wherein the account total of the user is debited by a predetermined amount.

40. A method according to claim 37, further including:
e) receiving an indication from the user as to whether a reward is claimed, and if a reward is claimed:
f) initiating the issue of the reward to the user and debiting the account total of the user by a predetermined amount.

41. A method according to claim 40, wherein the indication of step e) indicates which of a plurality of possible rewards is claimed, and the predetermined amount in step f) is dependent on which of the plurality of possible rewards is claimed.

42. A method of registering user details on a user database, comprising:
a) receiving a message from a mobile terminal, the message including a unique identifier associated with the mobile terminal and/or the user of the mobile terminal;
b) entering the unique identifier on the user database;
c) subsequently receiving the user details together with the unique identifier or a code related thereto; and
d) entering the user details on the user database so as to be associated with the unique identifier.

43. A method according to claim 42, wherein step a) is performed over a first, wireless network and step b) is performed over a second network different from the first network.

44. A method according to claim 42, wherein the message includes a code entered by a user.

45. In a competition scheme in which users enter a competition and at least one winner is selected from the entered users, a method comprising:
a) receiving a competition entry code from a mobile terminal together with a unique identifier;
b) verifying the competition entry code; and
c) storing the unique identifier on a database of competition entrants.

46. A method according to claim 45, wherein the unique identifier is an address of the mobile terminal on a wireless network.

47. A method according to claim 45, further including the step of transmitting a message to the mobile terminal confirming entry to the competition.

48. A method according to claim 46, further including:
d) selecting an entry from the database of competition entrants; and
e) transmitting a password to the address of the selected competition entrant.

49. A method according to claim 48, further including:
f) receiving said password;
g) receiving personal data of the selected competition entrant; and
h) issuing a prize to the selected competition entrant.

50. In a competition scheme in which users enter a competition and at least one winner is selected from the entered users, a method comprising:
a) receiving a competition entry code from a mobile terminal together with an address of the mobile terminal on the wireless network;
b) verifying the competition entry code;
c) storing the unique identifier on a database of competition entrants;
d) selecting an entry from the database of competition entrants;
e) transmitting a password to the address of the selected competition entrant;
f) receiving said password;
g) receiving personal data of the selected competition entrant; and
h) issuing a prize to the selected competition entrant.

51. A computer program arranged to perform a method according to any one of claims 28 to 50 when executed by suitably arranged hardware.

52. A carrier carrying a computer program according to claim 51.

53. A carrier carrying a data structure consisting of a database of user reward points comprising user records, each user record recording a reward point total for that user and being indexed according to a mobile terminal address for that user.

54. A carrier carrying a data structure consisting of a database of competition entrants indexed according to a mobile terminal address for each entrant.

55. A reward system, comprising:
a) a plurality of mobile terminals;
b) a plurality of vouchers bearing respective unique voucher codes;
c) a user account database storing user account records for a plurality of users, the user account records including a total value for each user account;
d) a host server for receiving said voucher codes transmitted by said mobile terminals, identifying for each received voucher code the identity of the mobile terminal and/or user which transmitted the voucher code, and adding to the respective user account record a voucher value corresponding to the received voucher code; and
e) a facility for issuing rewards to the users when their respective total values meet a predetermined criterion.

56. A competition system, comprising:
a) a plurality of mobile terminals;
b) a broadcast competition code;
c) an entrant database storing records of competition entrants;
d) a host server for receiving said competition code transmitted by said mobile terminals, identifying the mobile terminal and/or user which transmitted the competition code, and adding to the entrant database an identifying code corresponding to that mobile terminal and/or user; and
e) a facility for issuing a prize to one or more selected competition entrant.
